(19) United States
(12) Patent Application Publication
(10) Pub. No.: US 2024/0413719 A1
(43) Pub. Date: Dec. 12, 2024

(54) METHOD FOR PRODUCING A STATOR, IN PARTICULAR FOR AN EC MOTOR, AS WELL AS A STATOR AND AN ELECTRIC MACHINE PRODUCED ACCORDING TO THIS METHOD

(71) Applicant: Robert Bosch GmbH, Stuttgart (DE)

(72) Inventors: Stefan Marke, Buehl (DE); Tilo Koenig, Buehl (DE); Andreas Huehsam, Baden-Baden (DE); Kesavan Thinakaran, Coimbatore (IN); Pascal Chaumet, Strasbourg (FR)

(21) Appl. No.: 18/699,712

(22) PCT Filed: Oct. 7, 2022
(86) PCT No.: PCT/EP2022/077942

§ 371 Date: Apr. 9, 2024

(30) Foreign Application Priority Data
Oct. 22, 2021 (DE) 10 2021 211 926.3

(51) Int. Cl. H02K 15/02; B23P 19/02; H02K 1/14

(52) U.S. Cl. CPC H02K 15/022; B23P 19/02; H02K 1/148

(57) ABSTRACT

A method for producing a stator (14), in particular for an EC motor (13), as well as a stator (14) produced using said method and an electrical machine (12) produced using said method, which comprises the following method steps: —T-shaped lamination segments (20) of a lamination layer (21) are first completely punched out of a sheet metal region in the axial direction (8) —the lamination segments (20) are then pressed back against the axial direction (8) into the original axial position of the sheet metal region (18), wherein a yoke region (24) is punched out on the lamination segments (20), from which region a respective tooth (26) extends in a radially inward direction —wherein connecting lugs (30) of a first lamination segment (20) and a corresponding recess (31) of a second adjacent lamination segment (20) are designed such that these form an undercut (32) with respect to the tangential direction (9), which undercut keeps the adjacent lamination segments (20) connected to one another in the tangential direction (9) as an annular lamination layer (21) —axial stacking of the individual lamination layers (21) on top of one another to form a stator base body (17) comprising stator segments (22).

### BACKGROUND

The invention relates to a method for producing a stator, in particular for an EC motor, as well as to a stator and an electric machine produced by this method according to the type of invention in the independent claims.

DE 10 2020 204 576 A1 discloses a stator for an electrical machine, in which all T-shaped lamination segments are incompletely separated from a single sheet metal layer during punching in a first step using precut technology and are pressed back axially into their original position in a second step. As a result, a predetermined breaking point is created at the separation points in the yoke region, whereby the individual T-segments remain connected to each other over the entire circumference as the stator base body. During punching, the individual sheet metal layers are joined together axially by means of punched stacks. Immediately before winding the tooth shanks, the individual T-shaped segments are opened at the predetermined breaking points. After the tooth shanks have been wound, the separated T-segments are reassembled in their original position to form a ring, with the predetermined breaking points again interlocking tangentially.

The disadvantage of such a solution is that the predetermined breaking points are subject to significant fluctuations due to material fluctuations and the wear of the punching tool, which leads to a large variance in the separating forces to be applied between the stator segments. Due to the plastic deformation of the material during the separation process of the predetermined breaking points, the holding forces after joining are lower than before. The partial material cohesion given dividing points that are not completely punched through leads to fluctuations in the dividing forces.

### SUMMARY

In contrast, the advantage of the device and method according to the invention having the features of the independent claims is that, by producing a stator base body by means of what is referred to as the “precut” method, the advantages of a tooth shaft which is freely accessible for winding are combined with the advantages of a stator yoke, between the individual T-segments of which only a minimal joining gap remains. In a first step, all T-shaped sheet metal laminations of a lamination layer are in this case simultaneously separated from a single sheet metal layer during punching, and in a second step they are pressed axially back into their original position. At the separation points in the yoke region, an undercut is punched out in the tangential direction, as a result of which the individual T-segments remain connected to each other over the entire circumference as the stator base body. The individual metal sheet layers are joined together axially, so that the basic stator body is made up of individual T-shaped stator segments. Immediately before winding the tooth shafts, the individual T-shaped segments can be separated from the stator base body with a defined separating force. After the tooth shanks have been wound, the separated T-segments are reassembled in their original position to form a ring and held together by the undercut, whereby the undercuts interlock exactly tangentially at the dividing lines. The magnetic flux losses in the stator yoke are minimized thereby. In the solution according to the invention, the frictional connection (material cohesion) is eliminated by means of complete punching. The segments are held together in an interlocking manner (puzzle geometry). This means that tool wear no longer has a significant influence.

The measures explained in the dependent claims enable advantageous embodiments of and improvements to the embodiments specified in the independent claims. The connecting lug of a first lamination segment in this case extends on a first tangential side of the yoke region in the tangential direction, whereby the connecting lug is part of the dividing line and forms a connecting contour to a second tangential side of an adjacent second lamination segment. The connecting lug engages with the corresponding recess on the second tangential side of the adjacent second lamination segment. Using the precut technique, these two adjacent lamination segments are completely sheared off during punching, and then the first lamination segment is pressed back axially in relation to the second lamination segment so that both lamination segments are once again in the same axial position of the original metal sheet layer. By virtue of completely punching out the lamination segments, the dividing force for the lamination segments can be defined via the tangential interlocking connection because the dividing force depends largely on the dimension of the undercut and no longer on an undefined predetermined breaking point, which is generated by incomplete punching of the stator laminations. Precut technology enables the joining gap between the wound stator segments—and thus the magnetic flux losses between the yoke regions—to be minimized.

A mechanical undercut with respect to the tangential direction can be geometrically achieved by the connecting lug comprising a wider region in the radial direction than a minimum radial width of the recess. This can, e.g., be achieved with curved side flanks of the connecting lug in the form of a puzzle piece. Alternatively, the side flanks of the connecting lug can also comprise straight sections that form a flank angle to the tangential direction. For example, the two side flanks can be arranged in a wedge shape so that they widen in a radial direction towards the free end of the connecting lug. Such an interlocking connection reliably holds the adjacent lamination segments together. In particular, the holding forces during assembly after winding are approximately the same as the holding forces in the stator ring before winding.

The holding forces—or the dividing forces—between the stator segments can be adjusted by selecting the difference between the maximum radial extent of the connecting lug and the minimum radial extent of the corresponding recess such that the stator ring holds together without further auxiliary means. On the other hand, the stator ring can be divided before winding by means of a clearly defined dividing force. The deformation in this case is largely elastic, whereby plastic deformation is largely avoided. This difference in radial dimension is preferably in the range of 0.005 mm to 0.1 mm in order to avoid plastic deformation when the stator ring is opened.

In one alternative embodiment, the connecting lug is not symmetrical to the radial direction. In particular, a central axis of the connecting lug is inclined at an angle to the tangential direction, preferably radially inwards. Such a connecting lug engages with a recess—inclined by this angle of inclination to the tangential direction—to form the undercut. Such an angle of inclination is, e.g., 1° to 10°, measured at the tangential base region of the connecting lug. The advantage of this embodiment is that, after a first dividing line has been opened, the following stator segments can be divided from each other in a nearly force-free manner, as a result of which plastic deformation of the connecting lugs can be avoided.

The connecting lug is preferably arranged radially in the center of the yoke region. The radial distance between the outer circumference of the yoke region and the radially outer flank of the connecting lug is of the same order of magnitude as the radial distance between the inner circumference of the yoke region and the radially inner flank of the connecting lug. The maximum radial width of the connecting lug is preferably greater than its maximum tangential extension.

When punching the sheet metal laminations, the individual stator segments are connected to the axially adjacent sheet metal laminations in a particularly advantageous manner in a single operation by means of punched stacks. The need for an additional joining process between the axially layered sheet metal laminations is eliminated as a result. The punched stacks reliably hold the lamination segments of the individual stator segments together axially after they have been separated, so that their tooth shafts can be wound easily using a coil wire. In this case, multiple stator segments can, e.g., also be continuously wound using an uninterrupted coil wire. The punched stacks are preferably designed as elongated beads whose longitudinal direction is particularly favorably aligned along the magnetic field lines in the T-segment.

Once the stator segments have been removed from the packaged stator ring with virtually no plastic deformation of the material, the stator teeth can be wound with the coil wire in a freely accessible manner to achieve a high copper fill factor. Insulating masks are placed on the stator segments beforehand to insulate the coil wire from the laminations. This can, e.g., advantageously be performed before the individual stator segments are opened as an integral insulating mask ring, which is then also opened by the expansion of the stator segments, so that each stator segment then comprises its own T-shaped insulating mask before winding. Alternatively, individually manufactured T-shaped insulating masks can be placed on the stator segments after they have been expanded, whereby more individual parts have to be manufactured and assembled.

The dividing wedges are, e.g., inserted axially into the grooves of the stator base body in order to separate the T-segments. As a result, a tangential dividing force is created between adjacent tooth segments, which causes the stator segments to divide at the undercuts. Due to the defined punched-out geometry of the undercut on the connecting lug in accordance with the invention, even slightly unevenly applied dividing forces do not lead to any deformation of the connecting lug or its corresponding receptacle. Alternatively, radial dividing forces can be applied to the stator ring, causing the individual stator segments to divide explosively.

The geometry of the undercut is selected such that it can be separated solely by elastic deformation of the sheet metal laminations using a defined dividing force. The holding forces are generated by a largely elastic deformation of the connecting contour of the stator segments.

In one embodiment, the connecting lug comprises a flat surface at its tangentially outermost end, which runs approximately in the radial direction. This results in an additional defined guide when joining the adjacent T-segments, as this flattened surface of the connecting lug runs parallel to the radial boundary line between the two yoke regions radially outside the connecting lug. This flattened end of the connecting lug can merge into the side flanks of the connecting lug by means of bevels or curves in order to form the connecting contour between the adjacent yoke areas.

The T-shaped stator segments can be assembled to form an annular segment-shaped stator, whereby the respective yoke areas comprising the undercut regions interlock with one another in the tangential direction. The tooth shanks extend radially inwards from the yoke. An electric coil is wound on each of the tooth shanks, which then forms a magnetic pole acting in the radial direction on the tooth shoe. The electrical coil is preferably designed as a single-tooth coil, which is wound onto an insulating mask placed on the stator segment. Such a stator can be designed particularly advantageously to comprise 6, or 9, or 12, or 18 stator teeth, and preferably has an outer diameter of 25 mm to 120 mm.

The stator can be designed very cost-effectively as part of an electrical machine, in particular an electric motor. For this purpose, control electronics are preferably arranged axially above the stator segments, through which the individual electric coils are interconnected. The single-tooth coils can be connected in various ways to form an electronically commutated electric motor. In this embodiment, a rotor is arranged inside the teeth, on which permanent magnets are, e.g., arranged as magnetic poles.

### BRIEF DESCRIPTION OF THE DRAWINGS

Exemplary embodiments of the invention are illustrated in the drawings and explained in more detail in the following description.

Shown are:

FIG. 1 schematically, a cross-section of an electrical machine comprising T-shaped stator segments,

FIG. 2 a version of a stator base body according to the invention comprising an undercut between the yoke regions,

FIG. 3 an enlarged representation of a partial region of an undercut according to the invention as shown in FIG. 2, and

FIG. 4 a schematic detailed view of a further version of a stator base body.

### DETAILED DESCRIPTION

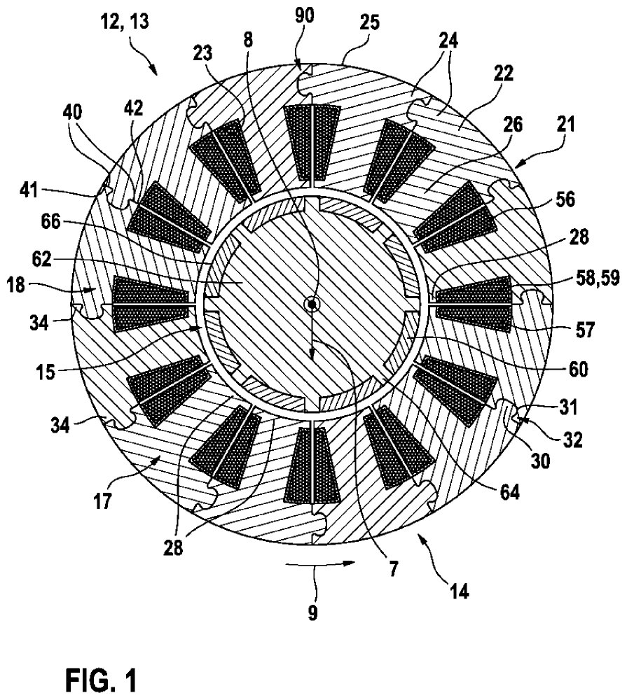

FIG. 1 an electrically commutated EC motor 13 as the electrical machine 12 according to the invention. The electric machine 12 comprises a stator 14 having a stator base body 17 on the radial outside. The stator base body 17 is composed of individual T-shaped stator segments 22, which comprise a radially outward yoke region 24, from which a respective tooth 26 extends radially inward. Tooth shoes 28 are formed at the radially inner end of the teeth 26 and then form the magnetic poles for the rotor 15 mounted radially inside the stator 14. Insulating masks 56, which are wound with an electrical winding 58, are arranged on each of the stator segments 22. In this exemplary embodiment, each stator segment 22 comprises a single-tooth coil 59 in the form of an electrical winding 58, which is connected to an electronic control system of the electrical machine 12 via a circuit arrangement (not shown). In this case, two or more stator segments 22 can, e.g., also be wound with an uninterrupted winding wire 57. The stator base body 17 is composed of individual lamination layers 21 that are stacked axially on top of each other. As a result, the individual stator segments 22 are composed of individual T-shaped lamination segments 20. Multiple stator segments 22 (e.g., 12 pieces) form the stator base body 17 over the entire circumference and, e.g., inserted into a motor housing (not shown). The individual stator segments 22 are divided from one another by lateral dividing lines 40, which extend approximately in the radial direction 7 from the outer circumference 25 of the yoke region 24 to its inner diameter 23. At a first dividing line 40 of a stator segment 22, a connecting lug 30 extends in the circumferential direction 9, which in the assembled state engages with a corresponding recess 31 of an adjacent stator segment 22. Together with the corresponding recess 31, the connecting lug 30 forms an undercut 32 with respect to the tangential direction 9. The rotor 15 in FIG. 1 comprises multiple permanent magnets 60, which are accommodated in a rotor base body 62. In this case, the permanent magnets 60 are, e.g., arranged on the radial surface of the rotor base body 62. Formed on the rotor base body 62 in the circumferential direction 9 between the permanent magnets 60 are retaining bars 64, which preferably separate the permanent magnets 60 in the circumferential direction 9 (which permanent magnets are magnetized in the radial direction 7). In this exemplary embodiment, the permanent magnets 60 are shell-shaped, so that the outer circumference 66 of the rotor 15 is approximately circular. In particular, eight permanent magnets 60 are arranged on the rotor 15 and interact with the twelve stator poles formed by the stator segments 22. The view in FIG. 1 shows a cross-section through the wound stator 14, along a lamination layer 21, which is composed of many individual—e.g., twelve—T-shaped lamination segments 20 in a ring shape.

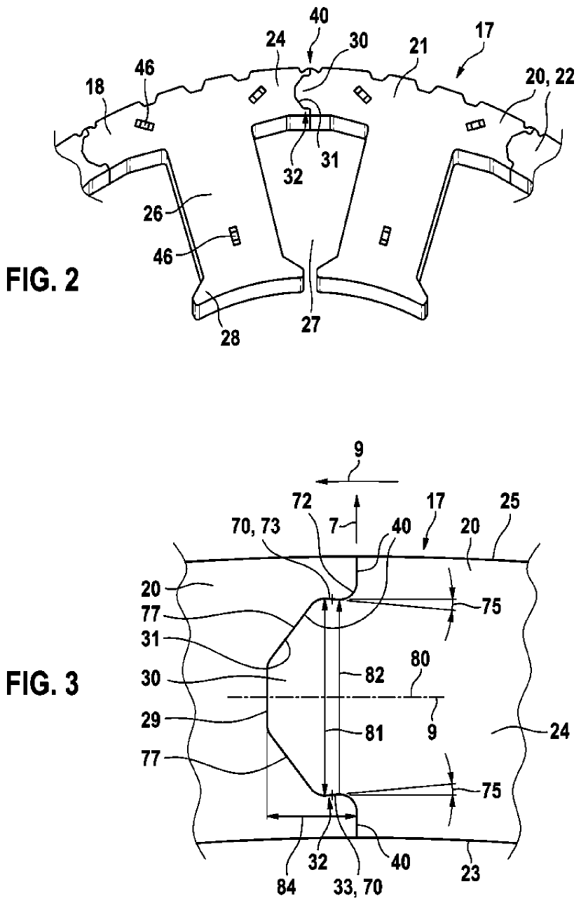

A section of an unwound stator base body 17 is shown in FIG. 2 using a specific geometry for the connecting lug 30 of the lamination segments 20. The lamination segments 20 are punched out of a sheet metal region, whereby the dividing lines 40 are formed on both sides of the yoke regions 24. Each lamination segment 20 comprises a stator tooth 26 comprising a tooth shoe 28 and, on the opposite, radially outer area, the yoke region 24, which extends beyond the stator tooth 26 in both circumferential directions 9. At the two free tangential ends 34 of the yoke region 24, connecting contours 41, 42 are formed by means of the punched dividing lines 40, at which two adjacent lamination segments 20 of a lamination layer 21 are connected to one another. The connecting lug 30 is punched out on a first connecting contour 41 and the recess 31 is punched out on the tangentially opposite second connecting contour 42. After the dividing line 40 has been completely punched through, the two adjacent lamination segments 20 are pressed back into a common plane of the lamination layer 21 against the punching direction. After complete separation, the adjacent lamination segments 20 are thus reassembled exactly identically to their original position before punching to form an annular stator plate 18. After punching and rejoining, the lamination layers 21 are joined together axially by means of punched stacks 46. As a result, a basic stator body 17 is created, whose individual stator segments 22 are held together by the interlocking connection between the individual lamination segments 20. In this type of precut technology, the lamination segments 20 are therefore not held together by a predetermined breaking point via incomplete punching, but by the undercut 32 in tangential direction 9, which the connecting lug 30 forms with the adjacent recess 31. The holding force between the adjacent stator segments 22 can in this case be defined by the geometry of the dividing line 40. The stator segments 22 are opened for winding in the tangential direction 9, and/or the radial direction 7, and fitted with the insulating mask 56. For example, insulating masks 56 are placed on both axial sides of the stator base body 17 before winding in order to insulate the winding wire 57 from the laminations of the stator segments 22. The insulating masks 56 can be formed as individual mask segments for each stator segment 22 separately. Alternatively, the insulating masks 56 can also be fitted as integral, annular insulating masks 56 on each axial side, which are then opened at the same time as the stator base body 17 before winding. The stator grooves 27 between the teeth 26 can be widened tangentially to such an extent that a wire nozzle of a needle winder can dip into the stator groove 27 in the radial direction 7 between two adjacent tooth shoes 28 in order to wind the winding wire 57 onto the teeth 26 with a high copper fill factor. FIG. 2 schematically shows the punched stacks 46, by means of which the individual lamination segments 20 are connected to one another in the axial direction 8. For example, a first punched stack 46 is arranged with its longitudinal extension in the radial direction 7 within the tooth 26. Two further punched stacks 46 are each arranged in the yoke region 24, with their longitudinal direction forming an angle to the circumferential direction 9 and ideally aligned along the magnetic field lines that occur.

FIG. 3 shows in detail an embodiment of a geometry of the connecting contours 41, 41 for the undercut 32 as shown in FIG. 2. The yoke regions 24 of the lamination segments 20 have an outer circumference 24 and an inner diameter 23. Both the outer circumference 25 and the inner diameter 23 can comprise regions that deviate from a circular arc. For example, axial grooves or a sinusoidal contour or flat surfaces can be integrated into the outer circumference 25 and/or on the inner diameter 23. The lateral boundary line 40 here runs radially outwards and radially inwards exactly in the radial direction 7. The connecting lug 30 extends from the lateral dividing line 40 in the circumferential direction 9, where it engages with the corresponding recess 31 of the adjacent lamination segment 20. The connecting lug 30 comprises an inner flank 33 and an outer flank 73, both of which deviate from the exact tangential direction 9. In particular, the inner flank 33 and the outer flank 73 each form a straight line 70, which form an angle of inclination 75 to the tangential direction 9. The inclination angles 75 are, e.g., in the range of 2° to 10° and are preferably symmetrical to one another. The straight lines 70 merge with a radius 72 into the radial sections of the dividing line 40. The connecting lug 30 in this case comprises, e.g., a flattened tip which is formed as a plane 29 in the radial direction 7. Bevels 77 are formed between the plane 29 and the flanks 33, 73, so that the connecting lug 30 is approximately wedge-shaped. The connecting lug 30 comprises a region with a maximum radial dimension 81 that is larger than a region with a minimum radial dimension 82 of the corresponding recess 31. As a result, when inserted, the connecting lug 30 together with the corresponding recess 31 forms an undercut 32 in the tangential direction 9, which holds the two adjacent lamella segments 20 firmly together. In this embodiment according to FIG. 3, the connecting lug 30 is symmetrical in the radial direction 7 within the yoke area 24 and has, e.g., a larger maximum radial dimension 81 than its tangential extension 84. In an alternative embodiment according to FIG. 1, the flanks 33, 73 and the slopes 77 are not formed as straight lines 70, but in the form of a puzzle piece 90, which comprises a head with a larger radial dimension 81 than the radial dimension 82 of a neck of the puzzle piece 90.

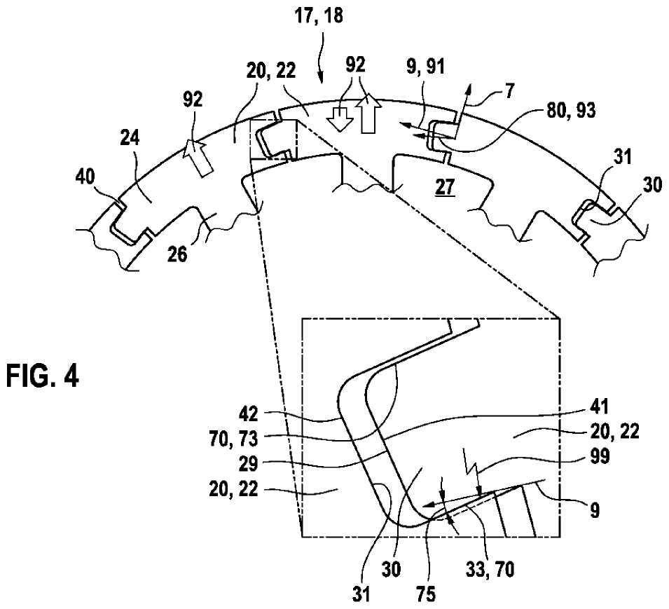

FIG. 4 shows a further embodiment of a stator base body 17 comprising an undercut 32 between adjacent lamination segments 20. In this design, the connecting lugs 30—and the corresponding recesses 31—are asymmetrical with respect to the radial direction 7. The inner flank 33 and the outer flank 73 are parallel to each other and both form the same angle of inclination 75 to the tangential direction 9. The inner flank 33 and the outer flank 73 are preferably designed as straight lines 70, but can alternatively both have a curvature. Due to the angle of inclination 75, this connecting lug 30 also forms an undercut 32 on its inner flank 33 comprising the corresponding recess 31 with respect to the tangential direction 9. The formation of this undercut 32 on the inner flank 33 is shown symbolically in the enlargement by a lightning bolt 99. If a tangential force 91 is exerted between two stator segments 22, this causes radial forces 92 through the undercut 32, which brace the connecting lug 30 in the recess 31. In this embodiment, if at least one stator segment 22 is detached from the annular stator base body 17—or the stator ring 17 is halved—all of the other stator segments 22 can be separated from each other for winding with virtually no dividing force. In the separated state of the stator ring 17, a tensile force 93 can be exerted along the flanks 33, 73, as a result of which no radial tension forces 92 occur.

It should be noted that, with regard to the exemplary embodiments shown in the drawings and in the description, a wide range of possible combinations of the individual features are possible. The specific shape of the individual lamination segments 20, the outer contour of the stator ring, the arrangement and number of teeth 26, and the design of the yoke regions 24 can, e.g., be varied accordingly. The radial position and dimensions of the connecting lug 30 and the corresponding recess 31 can also be adapted to the requirements of the electrical machine 12 and the manufacturing options thereof. The contour of the inner flank 33 and the outer flank 73 of the connecting lug 30 can also be varied in order to specify the dividing force between the stator segments 22 via the dimension of the undercut 32. The invention is particularly suitable for the rotary drive of components, or for the adjustment of parts in motor vehicles, but is not limited to these applications.

1. A method for producing a stator (14) comprising the following method steps:
punching T-shaped lamination segments (20) of a lamination layer (21) out of a sheet metal region in an axial direction (8)
pressing the lamination segments (20) back against the axial direction (8) into an original axial position of the sheet metal region (18), wherein a yoke region (24) is punched out on the lamination segments (20), from which region a respective tooth (26) extends in a radially inward direction
wherein connecting lugs (30) of a first lamination segment (20) and a corresponding recess (31) of a second adjacent lamination segment (20) are configured to form an undercut (32) with respect to a tangential direction (9), which undercut keeps the adjacent lamination segments (20) connected to one another in the tangential direction (9) as an annular lamination layer (21)
axially stacking individual lamination layers (21) on top of one another to form a stator base body (17) comprising stator segments (22).

2. The method according to claim 1, wherein the connecting lugs (30) and the corresponding recesses (31) are formed on connecting contours (41, 42) of the yoke regions (24) and are punched completely through.

3. The method according to claim 1, wherein, in order to form the undercut (32), the connecting lugs (30) comprise a region having a larger radial extent (81) than a region of a minimum radial extent (82) of the corresponding recesses (31).

4. The method according to claim 1, wherein the connecting lug (30) comprises two side flanks (33, 73), which extend in the tangential direction (9), and the side flanks (33, 73) form an angle of inclination (75) to the tangential direction.

5. The method according to claim 3, wherein a difference between the larger radial extent (81) of the connecting lugs (30) and the minimum radial extent (82) of the corresponding recesses (31) is approximately 0.005 mm to 0.1 mm.

6. The method according to claim 1, wherein, in order to form the undercut (32), a central axis (80) of the connecting lug (30) and a corresponding central axis (80) of the recess (31) deviate from the tangential direction (9) by an angle of inclination (75).

7. The method according to claim 6, wherein the angle of inclination (75) at a base of the connecting lug (30) is approximately 1° to 10°.

8. The method according to claim 1, wherein the individual lamination segments (20) are axially connected to one another by punched stacks (46), wherein a first punched stack (46) is formed in the tooth (26), and two further punched stacks (46) are formed symmetrically to one another in the yoke region (24).

9. The method according to claim 1, further comprising:
separating the individual stator segments (22) from the annular stator base body (17), wherein the connecting lug (30) is released from the recess (31) by elastic deformation,
insulating and winding the teeth (26) with electrical windings (58), thereby joining the stator segments (22) to form the annular stator base body (17) in a same way as the lamination segments (20) were previously joined together.

10. The method according to claim 9, wherein the T-shaped stator segments (22) are separated by dividing wedges, which are pressed axially inward.

11. The method according to claim 9, wherein, when the stator segments (22) are separated from the annular stator base body (17), the connecting lugs (30) and the corresponding recesses (31) are only deformed elastically, and not plastically.

12. The method according to claim 1, wherein, at tangential ends (34) of the yoke regions (24) where the connecting lugs (30) and recesses (31) are arranged, dividing lines (40) are formed between the stator segments (22), which lines extend approximately along the radial direction (7) over part of their radial extent, and tangential tips of the connecting lugs (30) are configured to be flattened, said dividing lines comprising a flat surface (29) along the radial direction (7).

13. A stator (14) produced according to a method according to claim 1, wherein in that the stator (14) includes a plurality of annular stator segments (22), wherein the undercut (32) between the connecting lugs (30) and the corresponding recesses (31) is designed-configured such that the stator segments (22) remain firmly connected to one another without further auxiliary means both before winding and after winding in order to transport and assemble the stator base body (17).

14. An electrical machine (12) comprising a stator (14) according to claim 13, wherein the electrical windings (58) of the individual T-shaped stator segments (22) are designed to be electronically commutatable by control electronics in order to drive a rotor (15) which comprises permanent magnet poles (60).

15. The method according to claim 1, wherein the stator is for an EC motor (13).

16. The method according to claim 4, wherein the two side flanks (33, 73) are symmetrical to one another.

17. The method according to claim 5, wherein a difference between the larger radial extent (81) of the connecting lugs (30) and the minimum radial extent (82) of the corresponding recesses (31) is approximately 0.01 mm to 0.05 mm.

18. The method according to claim 6, wherein the angle of inclination (75) deviates from the tangential direction (9) in a radially inward direction.

19. The method according to claim 7, wherein the angle of inclination (75) at the base of the connecting lug (30) is approximately 3° to 8°.

20. The method according to claim 10, wherein the dividing wedges are pressed axially inward on both opposite axial end faces between the teeth (26).
